(19) United States
(12) Patent Application Publication
(10) Pub. No.: US 2014/0020421 A1
(43) Pub. Date: Jan. 23, 2014

(54) AIR CONDITIONING UNIT AND METHOD OF INSTALLING THE SAME

(71) Applicant: Christopher J. Gallo, North Canton, OH (US)

(72) Inventor: Christopher J. Gallo, North Canton, OH (US)

(21) Appl. No.: 13/827,662

(22) Filed: Mar. 14, 2013

Related U.S. Application Data
(60) Provisional application No. 61/672,438, filed on Jul. 17, 2012.

(51) Int. Cl. F24F 1/02; B23P 11/00

(52) U.S. Cl. CPC F24F 1/027; B23P 11/00
USPC 62/263; 29/428

(57) ABSTRACT

An air conditioning unit and method of mounting the same in a hole in a wall, particularly a hole housing a window. The unit includes a front section disposed inside the building on a first side of the hole; and a rear section disposed outside the building on a second side of the hole. A duct extends between the front and rear sections and is clampingly engaged between the sill and a bottom end of the window. The duct includes a first duct member which moves cooled air in a first direction towards the inside of the building; and a second duct member which moves return air in a second direction away from the inside of the building. The duct is changeable in length to alter the distance between the front and rear sections so as to accommodate the air conditioning unit's installation in windows in different thickness walls.

### CROSS-REFERENCE TO RELATED APPLICATIONS

This Application claims the benefit of U.S. Provisional Patent Application Ser. No. 61/672,438 filed Jul. 17, 2012, the entire specification of which is incorporated herein by reference.

### BACKGROUND OF THE INVENTION

1. Technical Field

This invention relates generally to air conditioners. More particularly, this invention relates to a window-mounted air conditioning unit. Specifically, this invention is directed to an air conditioning unit which includes an expandable duct that enables the unit to be installed in holes or windows defined in different thickness walls, and to a method of installing the unit therein.

2. Background Information

Window-mounted air conditioning units are known in the art. Typically, these devices are generally rectangular in overall shape and are installed in the lower part of a double hung window. When installed, a bottom wall of the unit sits on part of the sill and the bottom of the lower window engages the top wall of the unit. The unit is thus sandwiched between the sill and the lower window and is thereby held in place.

There are a number of problems with these units. Firstly, they are difficult and potentially dangerous to install, especially in instances where they are installed in windows that are on a second or higher story of a building. Even small air conditioning units weigh quite a lot and that weight is unevenly distributed within the device. Consequently, the installer may accidentally lose control of the unit during installation and it may drop some distance to the ground below, leading to damage to the unit and potential injury to passersby.

Secondly, the units take up a substantial part of the space defined by the window. This reduces the amount of light coming into a room through that window. Still further, the units do not occupy the entire width of the window and because of the overall height of the unit; fairly substantially gaps are created on either side thereof. Even though baffles or some other type of obstruction are placed on either side of the unit, there may be fairly substantial exchange of air between the interior of the room and the air outside the building. This reduces the overall efficiency and effectiveness of the air conditioning unit. Additionally, the baffles block a lot of the light that could otherwise illuminate the interior of the room.

Additionally, previously known window air-conditioning units make a substantial amount of noise during operation.

There is therefore a need in the art for an improved window-mounted air conditioning unit which addresses some of the shortcomings of presently known devices.

### SUMMARY

An air conditioning unit mountable in a window on a wall of a building. The unit includes a front section configured to be disposed inside the building and on a first side of the window; and a rear section configured to be disposed outside the building and on a second side of the window. A duct extends between the front and rear sections and is positioned to be clampingly engaged between the window sill and a bottom end of the lower window. The front section of the unit hangs downwardly away from the sill and is disposed adjacent a first side of the wall. The rear section of the unit hangs downwardly away from the sill and is disposed adjacent a second side of the wall. The duct includes a first duct member which moves cooled air in a first direction towards the inside of the building; and a second duct member which moves return air in a second direction away from the inside of the building. The duct is changeable in length to alter the distance between the front and rear sections so as to accommodate the air conditioning unit's installation in different windows that are installed in walls of different thickness.

There is further disclosed a method of installing an air conditioning unit, as described above, in a window defined in a wall of a building. The method comprises the steps of:
changing the length of the duct which extends between the front section and rear section of the air conditioning unit;
resting the duct on the window sill;
positioning the front section inside the building and adjacent a first side of the wall beneath the window sill;
positioning the rear section outside the building and adjacent a second side of the wall beneath the window sill;
lowering the window so that the bottom end thereof contacts the upper surface of the duct.

The method further includes the step of moving the front and rear sections of the duct towards each other so that the wall is sandwiched therebetween.

The air conditioning unit is substantially quieter than previously known units. Previously known air conditioning units sit on the window sill, with the mechanical components thereof situated partially within the room or building and partially outside the room or building. The user can therefore readily hear those components operating. The air conditioning unit described herein is contemplated to have substantially all of its mechanical components situated outside of the building. The user will therefore not easily hear these components in operation, particularly because the window is closed, and more particularly because the mechanical components are positioned below the closed window.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a front elevational view of a window in which is mounted a window air conditioning unit, with the unit being shown from inside a room of a building and looking through the window to a location outside the building;

FIG. 2 is a perspective view of the air conditioning unit shown removed from the window;

FIG. 3 is a cross-sectional side view of the air conditioning unit taken along line 3-3 of FIG. 2;

FIG. 3A is an enlarged cross-sectional view of the highlighted region of FIG. 3;

FIG. 4 is a top view of the rear end of the air conditioning unit taken along line 4-4 of FIG. 3;

FIG. 5 is a top view of the air conditioning unit taken along line 5-5 of FIG. 3;

FIG. 6 is a front view of the air conditioning unit taken along line 6-6 of FIG. 3;

FIG. 7 is a rear view of the air conditioning unit taken along line 7-7 of FIG. 3; and

FIG. 8 is a cross-sectional side view of the air conditioning unit shown in an expanded condition and installed on a wider wall and window frame than the installation shown in FIG. 3.

Similar numbers refer to similar parts throughout the drawings.

### DETAILED DESCRIPTION

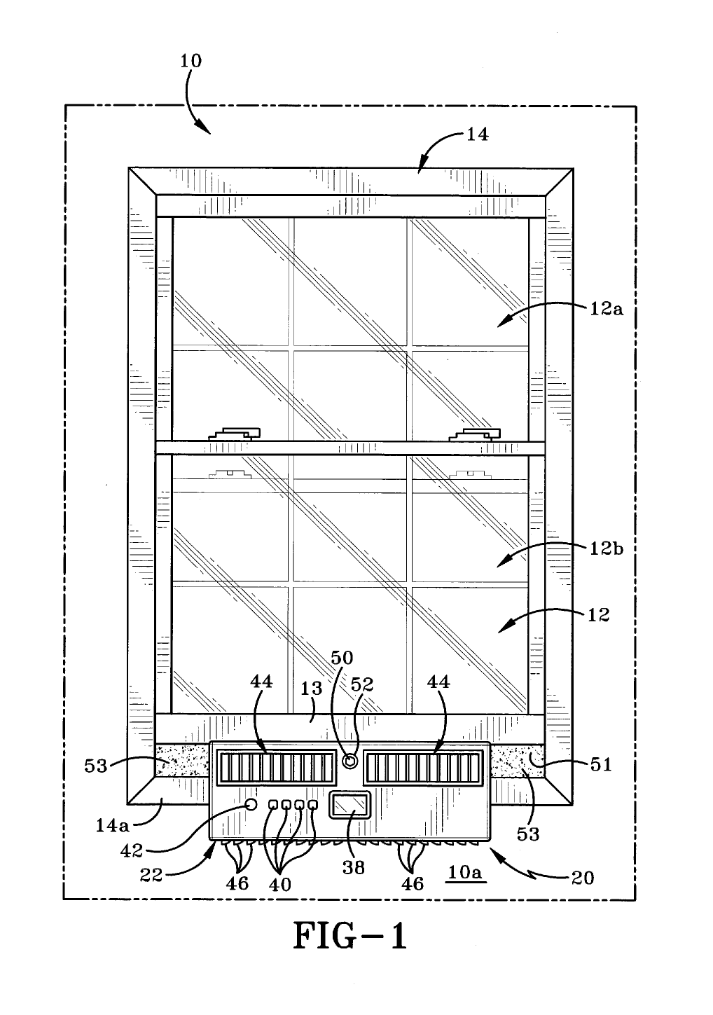

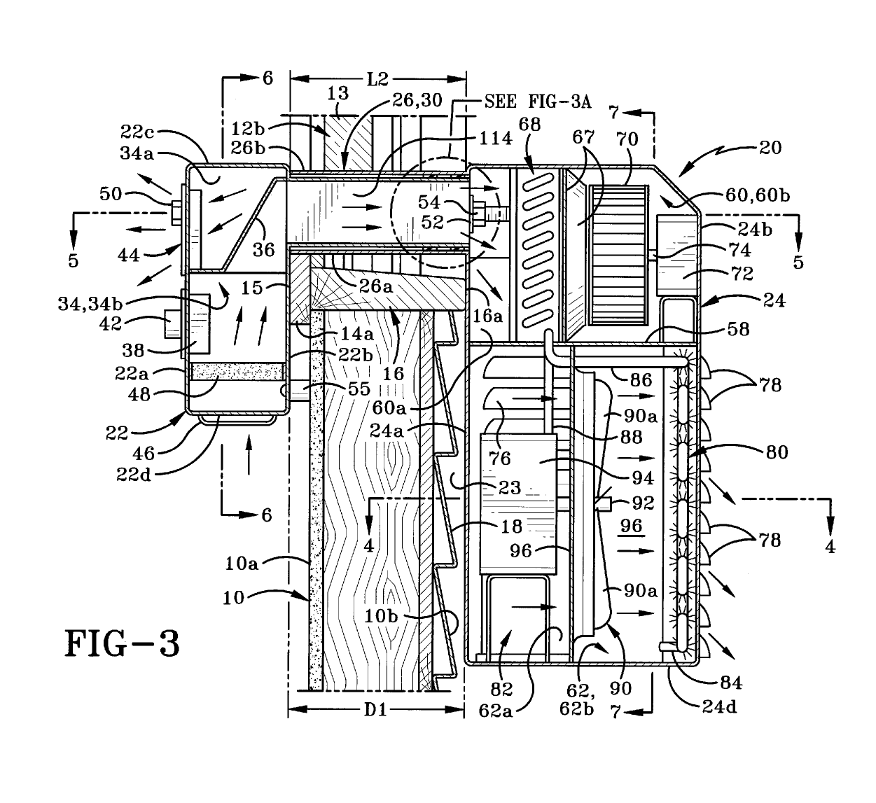

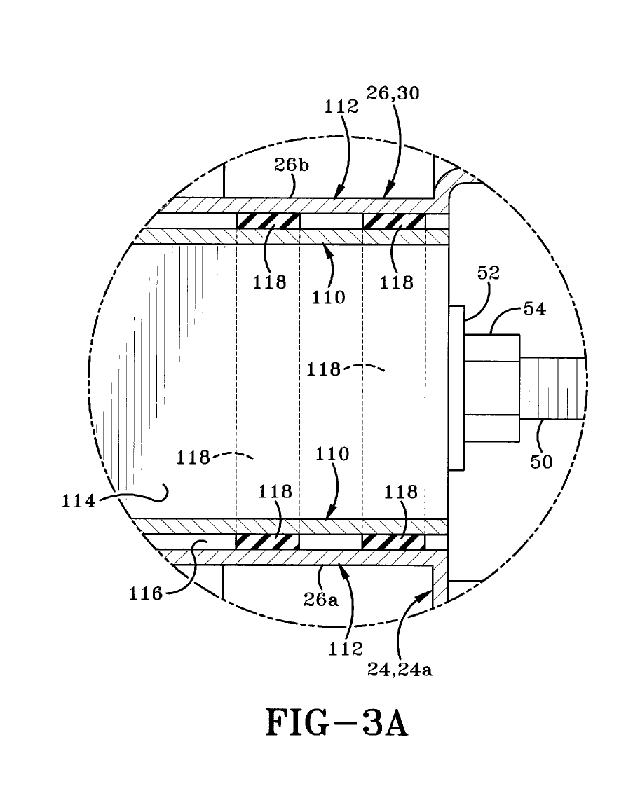

FIG. 1 shows a wall 10 within which is mounted a double-hung window 12 that is surrounded by a frame 14. Window 12 includes an upper window 12a and a lower window 12b. Lower window 12b may be raised and lowered relative to a window sill 16 (FIG. 3). The window 12 is shown from the perspective of a person looking from inside a room of a building toward the window 12. If one looks through the window 12a/12b one will see an area outside of the building. FIG. 3 shows that wall 10 includes a first side 10a that is located inside the room and on a first side of window 12; and a second side 10b that is located on the outside of the building and on a second side of window 12. Siding 18 is illustrated as being installed over the second side 10b of wall 10.

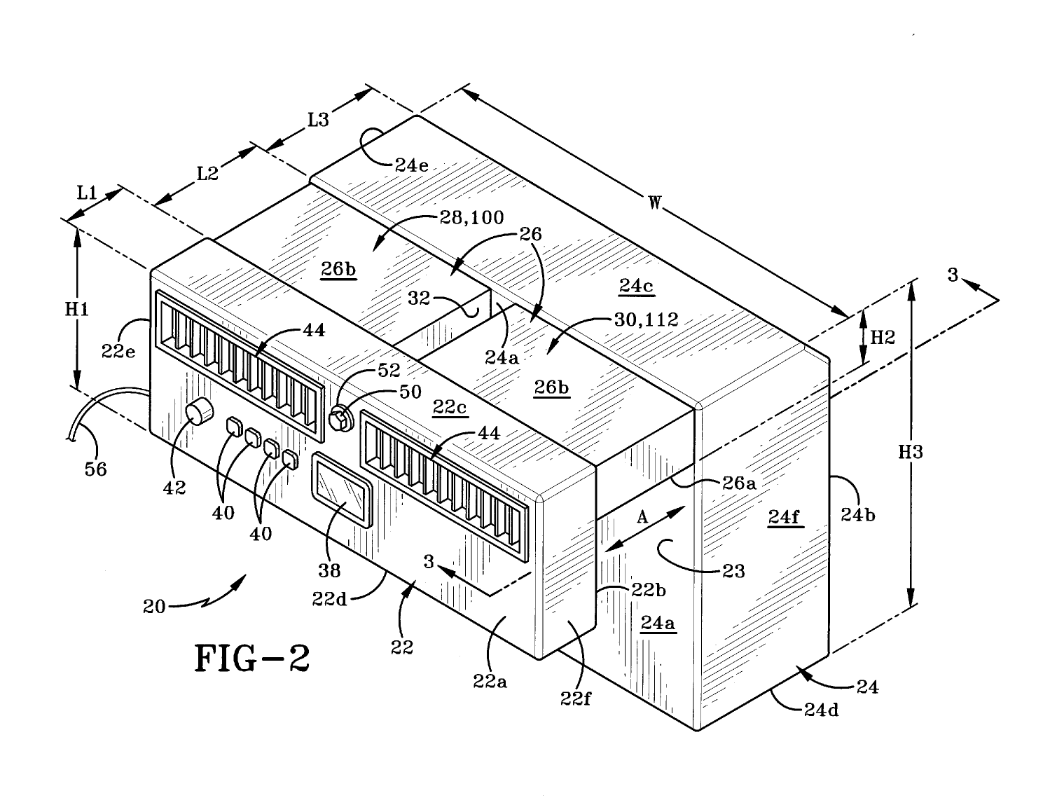

A window-mounted air conditioning unit is installed in window 12 and is generally indicated by the reference character 20. Air conditioning unit 20 as shown in greater detail in FIG. 2-7, comprises a front section 22, a rear section 24 and an air duct 26 that extends between front and rear sections 22, 24. As best seen in FIG. 3, air conditioning unit 20 is generally U-shaped when viewed in cross-section taken from one side of the device; as opposed to the generally square or rectangular configuration of previously known window-mounted air conditioning units.

Air conditioning unit 20 is installed in window 12 such that front section 22 thereof is retained within the room to be air conditioned, rear section 24 is retained outside of the building, and the air duct 26 extends between the interior and exterior of the building and is the only part of air conditioning unit 20 that is contacted by the lower window 12b. In particular, air conditioning unit 20 is secured in window 12 by duct 26 being wedged between the lower window 12b and sill 16. Still further, front section 22 is disposed adjacent and substantially parallel to first side 10a of wall 10 and on a first interior side of window 12. Rear section 24 is disposed adjacent and substantially parallel to second side 10b of wall and on a second exterior side of window 12. Wall 10 is substantially wedged between front and rear sections 22, 24.

Front section 22 preferably is a generally rectangular member that has a width “W”, a height “H1” and a length “L1”. Duct 26 comprises a first duct 28 and a second duct 30 which are laterally separated from each other by a gap 32. The overall width of duct 26 is slightly less than width “W”. The height of first and second ducts 28, 30 is substantially identical and is indicated as height “H2”. The length of the first and second ducts 28, 30, shown in FIG. 2, is length “L2”. As will be described further herein length “L2” is selectively telescopingly adjustable to change the distance between front and rear sections 22, 24 and therefore the size of the gap 23 (FIGS. 2 & 3) disposed therebetween. Rear section 24 is also a generally rectangular member that has substantially the same width “W” as front section 22 and is of a height “H3” and a length “L3”. As is evident from FIG. 2, the height “H2” of duct 26 is smaller than the height “H1” of front section 22, which in turn is smaller than the height “H3” of rear section 24. Thus, unlike presently known air conditioning units (not shown), the overall height of air conditioning unit 20 is not constant between its front end 22a and rear end 24b. Most advantageously, the height “H1” and length “L2” of front section 22 of air conditioning unit 20 disposed within the interior of the room to be cooled are relatively small in comparison to previously known devices. Additionally, front section 22 is not seated within the space defined by window frame 14. Instead, a portion of front section 22 hangs downwardly from the lower part 14a of frame 14 and sill 16 and is disposed adjacent first side 10a of wall 10. Still further, rear section 24 hangs downwardly from the lower part 14a of frame 14 and sill 16, and is disposed adjacent a second side 10b of wall 10. This arrangement makes it less likely that an installer will loose control of unit 20 during installation. This is because air conditioning unit 20 is generally U-shaped in cross-section and is thereby relatively easily engaged over the top of sill 16 without needing to be precariously balanced in place on top of the sill until engaged by the lower window 12b.

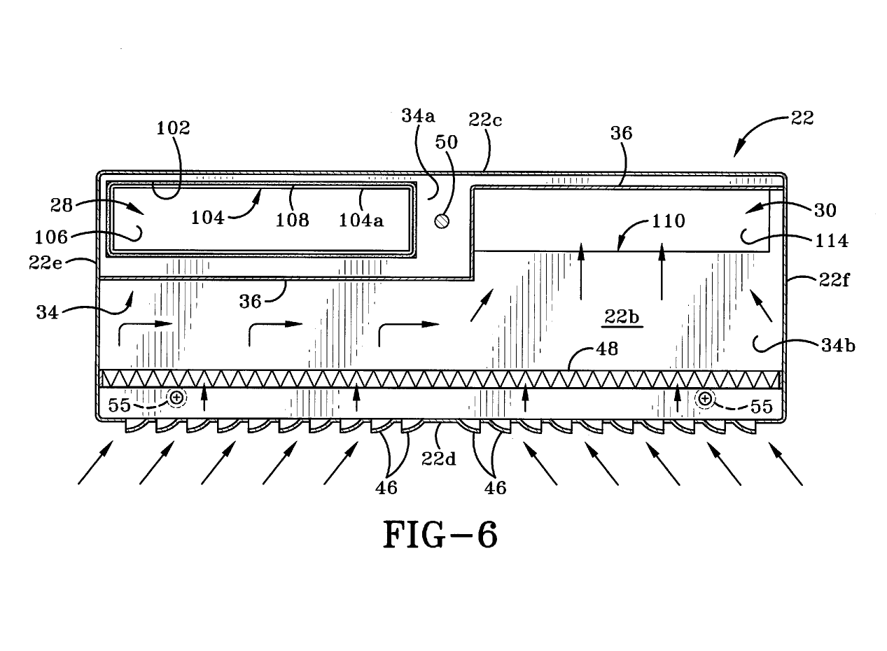

Referring to FIGS. 2 and 3, front section 22 includes a front wall 22a, a rear wall 22b, a top wall 22c, a bottom wall 22d, a first side 22e, and a second side 22f. Walls 22a-22f bound and define an interior compartment 34 (FIG. 6). Compartment 34 is divided into upper and lower chambers 34a, 34b (FIG. 3) by an angled interior wall 36. Front wall 22a includes a display screen 38 and control buttons 40 and knobs 42 for activating, setting and monitoring the functioning of air conditioning unit 20. It will be understood that any desired controls and displays may be provided on front section 22. Front wall 22a further includes one or more vents 44 which are in fluid communication with compartment 34, most particularly the upper chamber 34a thereof. Cooled air is able to exit unit 20 through vents 44, as will be hereinafter described.

FIG. 3 shows that bottom wall 22d is also provided with a plurality of vents 46. Vents 46 are in fluid communication with compartment 34, most particularly the lower chamber 34b thereof. Vents 46 are provided for return air from the room to be drawn into air conditioning unit 20. A filter 48 extends across lower chamber 34b of compartment 34 adjacent vents 46 to filter the return air.

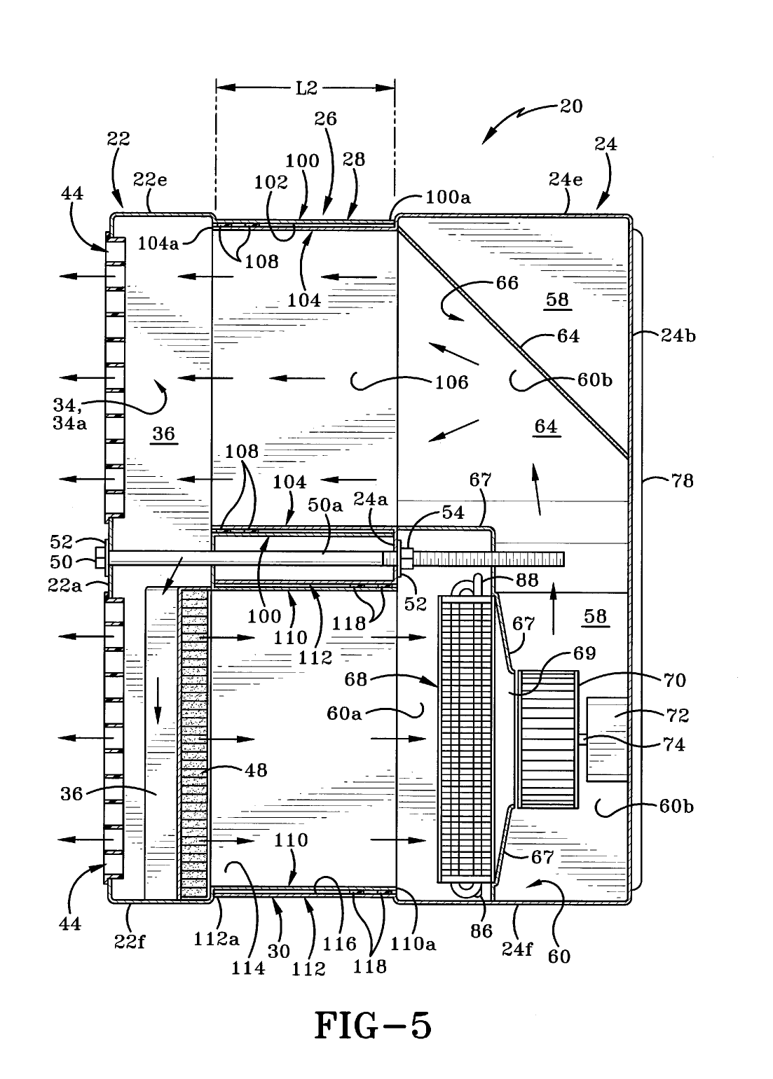

As shown in FIGS. 3 and 5, a threaded bolt 50, with associated washers 52 and nut 54 extends from front wall 22a of front section 22 through to front wall 24a of rear section 24. This bolt 50 maintains air conditioning unit 20 at a desired overall length that is determined by setting the length of duct 26, as will be hereinafter described. FIG. 2 shows that an electrical cord 56 extends outwardly from front section 22 of air conditioning unit 20 to connect the same to a remote outlet or other source of power (not shown).

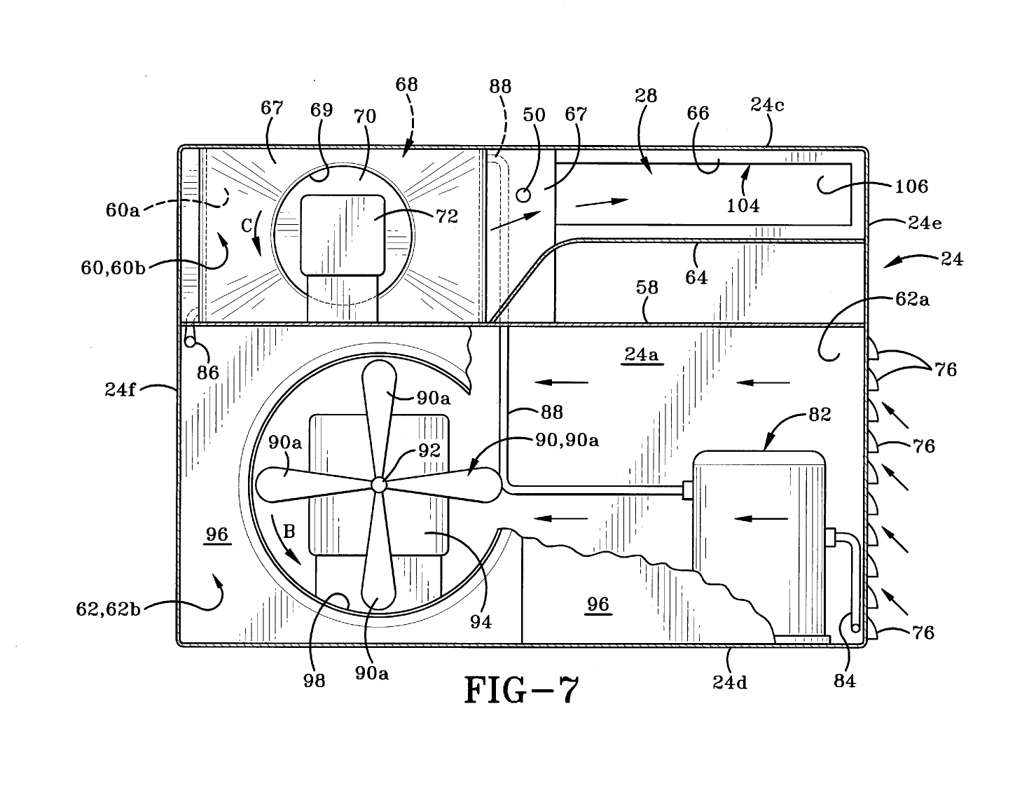

Rear section 24 of air conditioning unit 20 includes a front wall 24a, a rear wall 24b, a top wall 24c, a bottom wall 24d, a first side wall 24e, and a second side wall 24f. A horizontally oriented wall 58 (FIG. 3) divides the rear section into an upper compartment 60 and a lower compartment 62. Upper compartment 60 is bounded and defined by a first portion of front wall 24a, a first portion of rear wall 24b, top wall 24c, and upper portions of first and second side walls 24e, 24f. An angled wall 64 (FIG. 7) extends between horizontal wall 58 and first side wall 24de to create a channel 66 for directing air into first duct 28 as will be hereinafter described. A vertical wall 67 (FIGS. 3 & 5) extends between top wall 24a and horizontal wall 58 and divides upper compartment 60 into first and second chambers 60a, 60b. An aperture 69 (FIGS. 5 & 7) is defined in wall 67. An evaporator 68 and blower 70 are also situated in upper compartment 60 adjacent an exit to second duct 30. Evaporator 68 is located in first chamber 60a and blower 70 is located in second chamber 60b. In particular, blower 60b is positioned immediately adjacent aperture 69 in wall 67 between first and second chambers 60a, 60b. A first motor 72 is operatively engaged with blower 70 to rotate the same about drive shaft 74 and draw air through second duct 30, through first chamber 60a and move it into second chamber 60b.

Lower compartment 62 is bounded and defined by a second portion of front wall 24a, a second portion of rear wall 24b, bottom wall 24d, and lower portions of first and second side walls 24e, 24f. A plurality of vents 76 (FIG. 7) are provided on first side wall 24e. Vents 76 are in fluid communication with lower compartment 62 and are provided to draw air from outside of the building and into air conditioning unit 20. A plurality of vents 78 (FIG. 3) are provided in rear wall 24b and these vents 78 are in fluid communication with lower compartment 62. Vents 78 are provided to permit heated air to exit lower compartment 62 and be released into the environment outside of the building.

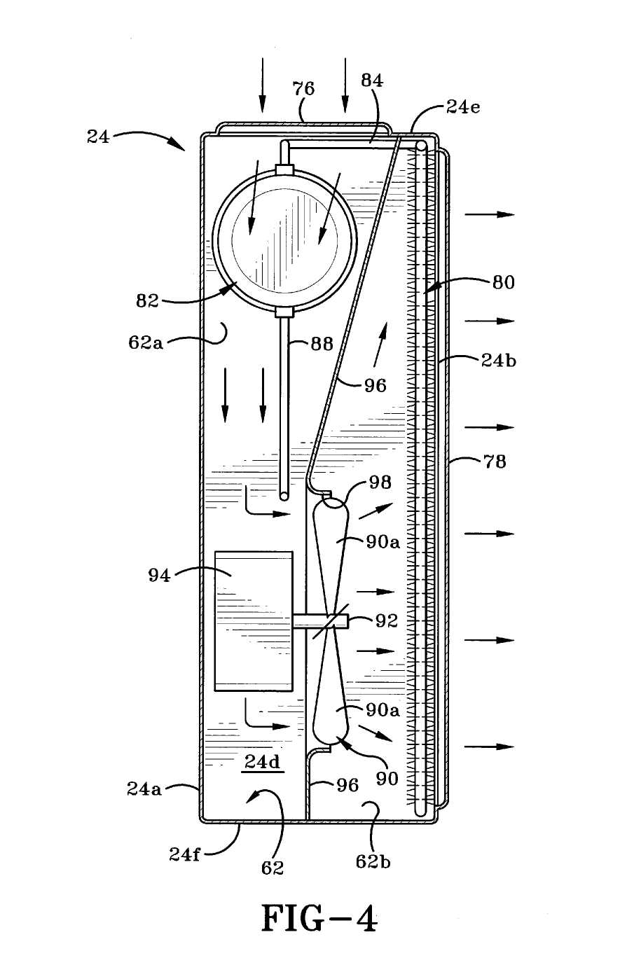

A plurality of components is housed in lower compartment 62. A condenser 80 (FIG. 4) is positioned adjacent rear wall 24b and vents 78. A compressor 82 is operatively connected to a first end of condenser 80 by a first tube 84. A second tube 86 (FIG. 3) extends between a second end of condenser 80 and evaporator 68 in upper compartment 60. A third tube 88 (FIG. 3) extends between compressor 82 and evaporator 68. A fan 90 is connected by way of a drive shaft 92 to a second motor 94. Fan 90 is positioned so that the blades 90a thereof are spaced a distance from a first region of condenser 80. It will be understood that instead of air conditioning unit 20 including both of the first and second motors 72, 94, unit 20 may alternatively be configured to include only a single motor which provides power to all of the powered components. In this latter instance, components like fan 90 and blower 70 may be operatively connected together by a drive belt (not shown). It will be understood that there are suitable electrical connections between the remote power outlet and the components within second section 24 but these have not been illustrated in the figures for the sake of clarity.

As is evident from FIGS. 4 and 7, a vertical wall 96 extends between horizontal wall 58 and bottom wall 24d. Wall 96 has an opening 98 therein that is substantially circular and is of generally the same diameter as fan 90. A portion of wall 96 is cut-away in FIG. 7 to show the compressor 82 and first and third tubes 84, 88. Wall 96 divides lower compartment into front and rear chambers 62a, 62b (FIG. 4). Wall 96 enables the air flow through lower compartment 62 to be redirected as illustrated by the unnumbered airflow arrows in the various figures.

As indicated previously herein duct 26, which extends between front and rear sections 22, 24, is comprised of first and second ducts 28, 30. First duct 28 extends between upper chamber 34a of front section 22 and second chamber 60b of upper compartment 60 of rear section 24. Second duct 30 extends between lower chamber 34b of front section 22 and first chamber 60a of upper compartment 60 of rear section 24.

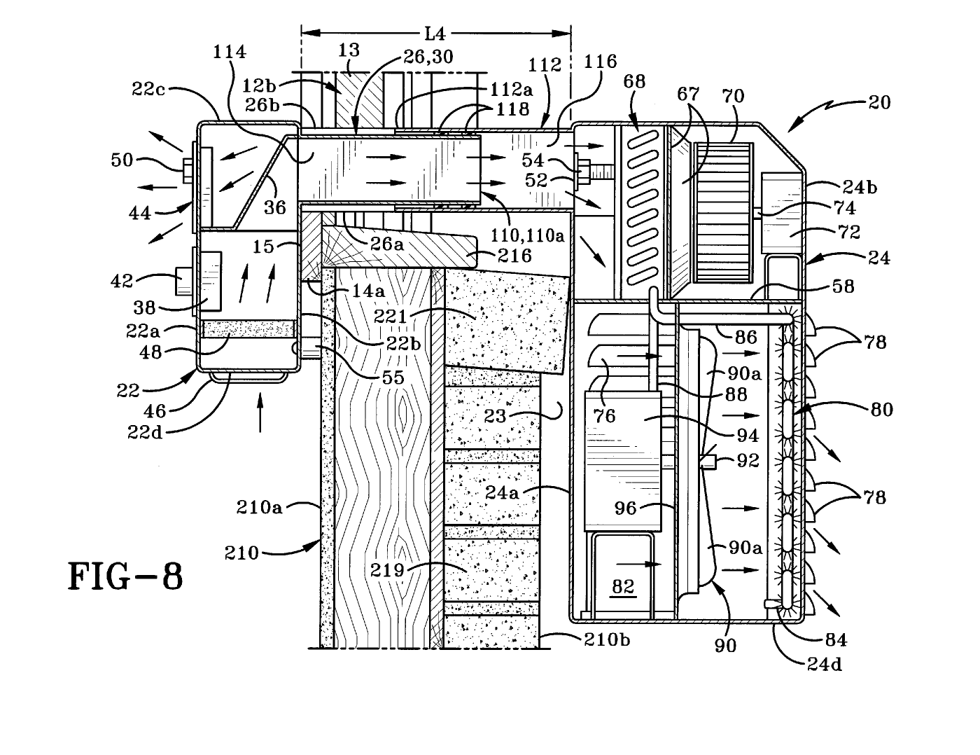

Duct 26 is a telescoping duct that is able to be adjusted to change the distance between rear wall 22b of front section 22 and front wall 24a of rear section 24. Particularly, duct 26 telescopes to change the size of gap 23 between a first length “L2” (FIGS. 1-3) and a second length “L4” (FIG. 8). Duct 26 is able to move between a first collapsed position where gap 23 has a size “L2” and a second expanded position where gap 23 has a size “L4”.

Referring to FIG. 5 there is shown the construction of first duct 28. First duct 28 is comprised of a first duct member 100 and a second duct member 104 that are telescopingly engaged with each other. First duct member 100 is integral with front section 22 and extends for a distance rearwardly from rear wall 22b thereof. First duct member 100 is a tubular sleeve that is generally rectangular in cross-sectional shape and defines a first bore 102 therein. First duct member 100 terminates in an outermost edge 100a. Second duct member 104 is integral with rear section 24 and extends for a distance forwardly from front wall 24a thereof. Second duct member 104 is a tubular sleeve that is generally rectangular in cross-section shape and defines a second bore 106 therein. Second duct member 104 is sized so as to be receivable within the bore 102 of first duct member 100. Second duct member 104 terminates in an outermost edge 104a. Seals 108 are provided between the interior surface of first duct member 100 and the exterior surface of second duct member 104. Seals 108 preferably are secured to the second duct member 104. Air flows through bore 106 of second duct member 104 when air conditioning unit 20 is operated.

In a similar fashion, second duct 30 is constructed of a third duct member 110 and a fourth duct member 112 that are telescopingly engaged with each other. Third duct member 110 is integral with front section 22 and extends for a distance rearwardly from rear wall 22b thereof. Third duct member 110 is a tubular sleeve that is generally rectangular in cross-sectional shape and defines a third bore 114 therein. Third duct member 110 terminates in an outermost edge 110a. Fourth duct member 112 is integral with rear section 24 and extends for a distance forwardly from front wall 24a thereof. Fourth duct member 112 is a tubular sleeve that is generally rectangular in cross-sectional shape and defines a second bore 116 therein. Third duct member 110 is sized so as to be receivable within the bore 116 of fourth duct member 112. Fourth duct member 112 terminates in an outermost edge 112a. Seals 118 are provided between the interior surface of fourth duct member 112 and the exterior surface of third duct member 110. Seals 118 preferably are secured to third duct member 110. Air flows through third bore 114 of third duct member 110 when air conditioning unit 20 is operated.

Air conditioning unit 20 is installed and used in the following manner. The installer will first measure the thickness of wall 10 to determine how great a length to set duct 26 at for installation. This is accomplished by measuring the distance “D1” between the innermost part of window 12 or wall 10, and the outermost part window 12 or wall 10. FIG. 3 shows that this distance “D1” is measured between an interior surface 15 of window frame member 14a and the outermost edge 16a of sill 16. Duct 26 is then adjusted in length to initially be longer than distance “D1” so that unit 20 may be easily positioned in the open window 12. Duct 26 is adjusted by rotating bolt 50 in a first direction to loosen the engagement of front and rear sections 22, 24 and this causes the length of the shaft 50a (FIG. 5) between nut 54 and bolt 50 to increase, thereby increasing the size of gap 23. (Conversely, when bolt 50 is rotated in a second direction, the length of the shaft 50a between nut 54 and bolt 50 is decreased and front and rear sections 22, 24 are drawn towards each other closing the size of the gap 23.) When bolt 50 is sufficiently loosened, the installer will pull front and rear sections 22, 24 away from each other in the direction of arrows “A” (FIG. 2) to increase length “L2” so that it is greater than distance “D1”. This pulling motion causes a length of second duct 104 to be pulled outwardly from within the bore of first duct 100 so that end 100a of first duct 100 is moved a distance away from second section 24. Simultaneously, a length of third duct 110 is pulled outwardly from within the bore of fourth duct 112 so that end 112a of fourth duct 112 is moved a distance away from front section 22. The arrangement ensures that substantially the same length of duct is pulled outwardly in an even, smooth motion from the bores of the first and fourth ducts 100, 112. Alternatively, if the movement is in the opposite direction, the arrangement ensures that the motion of pushing front and rear sections 22, 24 toward each other is a smooth, even or non-skewed motion. The arrangement ensures that rear wall 22b of front section 22 remains substantially parallel to front wall 24a of second section 24 at all times.

Air conditioning unit 20 is then positioned in the space created by raising lower window 12b away from bottom frame member 14a. Unit 20 is positioned so that front section 22 is disposed inside the room and adjacent first side 10a of wall 10, and second section 24 is disposed outside of the building and adjacent second side 10b of wall 10. Additionally, bottom surface 26a of duct 26 contacts and rests upon sill 16, or upon the uppermost regions of bottom window frame 14a. When unit 20 is resting in this position the bolt 50 is rotated in the second direction to draw front and rear sections 22, 24 toward each other in the opposite direction of arrow “A”. This motion is continued until rear wall 22b of front section 22 is adjacent the interior surface 15 of window frame member 14a or first side 10a of wall 10; and front wall 24a of second section 24 is adjacent the outermost exterior surface of sill 16 or second side 10b of wall 10. Thus, wall 10 is sandwiched between front and rear sections 22, 24. Window 12b is then lowered so that a lower end 13 thereof contacts upper surface 26b of duct 26. Duct 26 is therefore clampingly retained between lower end 13 of window 12 and sill 16. At this point, gravity and window 12b keep unit 20 in place. Any tendency of unit 20 to rotate and drop out of window 12 to the outside of the building is resisted because front section 22 somewhat counterbalances the weight of second section 24. It should be noted that the same installation method applied to installing unit 20 into a window having a greater wall thickness “D2” as illustrated in FIG. 8.

At this point, a small gap 51 (FIG. 1) is defined on either side of unit 20 and between bottom end 13 of window 12, window frame 14 and sill 16. Unit 20 preferably is provided with baffles 53 to block gap 51 so as to prevent mixing of air within the building with the air disposed outside the building. Alternatively, baffles 53 may be replaced with foam blocks or other similar obstructions to close off gap 51. It should also be noted that when unit 20 is installed, a spacer foot 55 (FIG. 3) mounted on rear wall 22b of front section 22 contacts the front surface of first side 10a of wall 10 and keeps front section 22 in an orientation where it is substantially parallel to first side 10a of wall 10.

Once unit 20 is safely installed in window 12, control buttons 40 and knobs 42 are then engaged to switch unit 20 on to cool the air within the interior the room. Unit 20 substantially functions in all other ways in the same manner as known air conditioning units to cool and circulate air. The rotation of fan 90 and blower 70 is indicated by arrows “B” and “C” respectively in FIG. 7. The airflow through air conditioning unit 20 is illustrated by way of the unlabeled arrows shown throughout the figures. Suffice to say to that return air is taken into air conditioning unit 20 from the room through vents 46 and cool air is expelled into the room through vents 44. Furthermore, air is drawn into the second section 24 of air conditioning unit from the air outside the building, through vents 76 and is expelled from second section 24 and into the air surrounding the building through vents 78.

A method of installing an air conditioning unit 20 in a window 12 defined in a wall 10 of a building comprises the steps of:
changing the length of duct 26 extending between front section 22 and rear section 24 of the air conditioning unit 20;
resting duct 26 on window sill 16;
positioning front section 22 inside the building and adjacent a first side 10a of wall 10 beneath the window sill;
positioning rear section 24 outside the building and adjacent a second side 10b of wall 10 beneath the window sill;
lowering window 12 so that bottom end 13 thereof contacts upper surface 26b of duct 26.

The method further includes the step of moving front and rear sections 22, 24 of duct 26 towards each other so that wall 10 is sandwiched therebetween.

It will be understood that while the air conditioning unit has been described above as being mountable within a window of a building, it may alternatively be mounted through a hole in the wall of the building in a location free of a window. In this instance, the duct 26 will be positioned in the hole in the wall and the front and rear sections 22, 24 will be on opposite sides of the wall. The hole in the wall would be cut to be substantially equal in size to duct 26. The through bolt 50 could be removed and the unit would be installed in two pieces, with the front 22 being on an inside of the wall and the rear 24 being on an exterior side of the wall. Once the front and rear 22, 24 have been matingly engaged together via duct 26 being inserted through the hole in the wall, the through bolt 50 could be reinstalled to hold front 22 and rear 24 together. The term “window” should therefore be interpreted to mean any suitably sized hole or aperture defined in a building wall, whether a window frame and sheet of glass mounted in that frame are present on not.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. An air conditioning unit for mounting in a hole defined in an exterior wall of a building, said unit comprising:
a front section adapted to be situated within an interior space within the building and on a first side of the wall;
a rear section adapted to be situated outside the building and on a second side of the wall; and
a duct extending between the front and rear sections; and wherein the duct is adapted to be disposed within the hole.

2. The air conditioning unit as defined in claim 1, wherein the duct is of a length measured between the front and rear sections; and the length of the duct is selectively changeable to alter the distance between the front and rear sections.

3. The air conditioning unit as defined in claim 2, wherein the duct includes a first region adjacent the front section of the unit; and a second region adjacent the rear section of the unit; and the first region is telescopingly engaged with the second region.

4. The air conditioning unit as defined in claim 2, wherein the duct comprises a first duct member that extends between the front and rear sections; and a second duct member that extends between the front and rear sections; and the first and second duct members are disposed laterally adjacent each other.

5. The air conditioning unit as defined in claim 4, wherein the first duct member is configured to permit airflow from the front section to the rear section; and the second duct member is configured to permit airflow from the rear section to the front section.

6. The air conditioning unit as defined in claim 4, wherein the first duct member is adapted to enable the flow of warm air from the front section of the unit to the rear section thereof; and the second duct member is adapted to enable the flow of cooled air from the rear section of the unit to the front section thereof.

7. The air conditioning unit as defined in claim 1, wherein the front section, rear section and duct form a generally U-shaped member when viewed from the side.

8. The air conditioning unit as defined in claim 1, wherein the hole in the building wall is occupied by a window; and the duct has an upper wall and a lower wall; and the lower wall of the duct is adapted to rest upon a sill of the window; and the upper wall of the duct is adapted to be engaged by a lower edge of the window when the lower wall is resting on the sill.

9. The air conditioning unit as defined in claim 1, wherein the front section of the unit is adapted to be disposed adjacent a front surface of a portion of the building wall beneath the hole, and the rear section is adapted to be disposed adjacent a rear surface of the portion of the wall beneath the hole.

10. The air conditioning unit as defined in claim 1; wherein the front section is of a first height and the duct is of a second height, and the second height is smaller than the first height,

11. In combination:
a wall having a front surface and a rear surface;
an opening defined in the wall and extending between the front and rear surfaces;
a window disposed within the opening; said window having a window sill and a lower window member that is movable toward and away from the sill; and
an air conditioning unit that is engageable in the window; said air conditioning unit comprising:
a front section;
a rear section; and
a duct extending between the front and rear sections; and wherein a lower wall of the duct rests upon the window sill; the front section is disposed adjacent the front surface of the wall; and the rear section is disposed adjacent the rear surface of the wall; and the lower window member engages an upper wall of the duct.

12. The combination as defined in claim 11, wherein the duct is of a length measured between the front and rear sections thereof; and the length of the duct is selectively changeable to alter the distance between the front and rear sections of the air conditioning unit.

13. The combination as defined in claim 11, wherein each of the front section and rear section of the air conditioning unit are substantially free of contact with the lower window member and the window sill.

14. The combination as defined in claim 11, wherein each of the front section and rear section of the air conditioning unit hang downwardly from the duct and extend for a distance below the window sill.

15. The combination as defined in claim 11, wherein the duct comprises a first duct member that extends between the front and rear sections; and a second duct member that extends between the front and rear sections; and the first and second duct members are disposed laterally adjacent each other; and the first duct member is configured to permit airflow from the front section of the air conditioning unit to the rear section thereof; and the second duct member is configured to permit airflow from the rear section to the front section.

16. The combination as defined in claim 15, wherein the first duct member is adapted to enable the flow of warm air from the front section of the air conditioning unit to the rear section thereof; and the second duct member is adapted to enable the flow of cooled air from the rear section of the air conditioning unit to the front section thereof.

17. The combination as defined in claim 11, wherein the front section, rear section and duct form a generally U-shaped member when viewed from the side; and at least a portion of each of the front section and rear section extend downwardly below a bottom wall of the duct.

18. A method of installing an air conditioning unit in a window disposed in an opening in a wall of a building; said method comprising the steps of;
changing a length of a duct which extends between a front section and a rear section of the air conditioning unit, so that the length is greater than wall's thickness;
resting a lower wall of the duct on a sill of the window;
positioning the front section of the air conditioning unit inside the building and adjacent a first side of the wall beneath the window sill; and
positioning the rear section of the air conditioning unit outside the building and adjacent a second side of the wall beneath the window sill.

19. The method as defined in claim 18, further comprising the step of:
lowering the window so that a bottom end thereof contacts an upper wall of the duct; and
retaining the duct between the bottom end of the window and the window sill.

20. The method as defined in claim 18, further comprising the step of;
moving the front and rear sections of the air conditioning unit towards each other to decrease the length of the duct; and
sandwiching the wall between the front and rear sections of the air conditioning unit.
